(19) United States
(12) Patent Application Publication
(10) Pub. No.: US 2016/0356877 A1
(43) Pub. Date: Dec. 8, 2016

(54) SYSTEM AND METHOD FOR MEASURUNG AN OBJECT LOCATION AND/OR ORIENTATION USING RADIO FREQUENCY PROPAGATION MEASUREMENTS

(71) Applicant: VAYYAR IMAGING LTD, Yehud (IL)

(72) Inventors: Raviv MELAMED, Nes Ziona (IL); Moshe SHAY, Petach Tikva (IL); Damian HOFFMAN, Tzur Yitzhak (IL); Shachar SHAYOVITZ, Ness Ziona (IL); Rohi HALIMI, Moshav Shokeda (IL)

(21) Appl. No.: 15/174,028

(22) Filed: Jun. 6, 2016

Related U.S. Application Data
(60) Provisional application No. 62/171,260, filed on Jun. 5, 2015.

(51) Int. Cl. G01S 5/02; G06F 3/01

(52) U.S. Cl. CPC G01S 5/0273; G01S 5/0247; G06F 3/01

(57) ABSTRACT

The methods, system and device disclosed herein provide a controller for controlling a computer device, the controller comprising a plurality of Radio Frequency (RF) transmitting units or repeating units, the RF transmitting units are configured to generate RF signals the RF signals differ in frequency and/or time and/or coding scheme between said units in a scene; a receiver comprising a plurality of RF receiving units, said RF units are configured to receive reflections of the RF signals; and a computer processor configured to analyze the RF reflected signals and measure the location and/or orientation of the controller in said scene

### CROSS-REFERENCE

The present application claims the benefit of U.S. Provisional Application Ser. No. 62/171,260, filed on Jun. 5, 2015, entitled “SYSTEM AND METHOD FOR MEASURING AN OBJECT LOCATION AND ORIENTATION USING RF PROPAGATION MEASUREMENTS” (attorney docket no. VY020/USP), the entire disclosures of which are incorporated herein by reference. The subject matter of the present application is related to PCT Application PCT/IL2015/050126, filed Feb. 4, 2015, entitled “SYSTEM DEVISE AND METHOD FOR TESTING AN OBJECT” (attorney docket no. VY005/PCT), PCT Application PCT/IL2015/050099, filed on Jan. 28, 2015, entitled “SENSORS FOR A PORTABLE DEVICE” (attorney docket no. VY003/PCT), U.S. application Ser. No. 14/605,084, filed on Jan. 26, 2015 entitled “VECTOR NETWORK ANALYZER” (attorney docket no. VY001/US) U.S. application Ser. No. 14/499,505, filed on Sep. 30, 2015 entitled “DEVICE AND METHOD FOR CALIBRATING ANTENNA ARRAY SYSTEMS” (attorney docket no. VY002/US) U.S. application Ser. No. 14/696,81, filed on Apr. 27, 2015 entitled “PRINTED ANTENNA HAVING NON-UNIFORM LAYERS” (attorney docket no. VY006/US) each of which is incorporated herein by reference in its entirety.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### FIELD OF THE INVENTION

The present invention relates to a system, device and method for measuring an object location and orientation in space, and more specifically, but not exclusively, to a system, device and method for measuring one or more objects location and orientation in space using multi-RF (Radio Frequency) units.

### BACKGROUND OF THE INVENTION

Prior to the background of the invention being set forth, it may be helpful to set forth definitions of certain terms that will be used hereinafter.

The term ‘Controller’ as used herein is defined as an input device used for controlling a device for example for playing video games. Several such input devices can be used in conjugation to allow, for example, to control multi pointing devices in a video game separately. The term “Multi controller” is used to describe such system.

Motion sensing systems such as systems which allow the user to interact with and manipulate items on screen via gesture recognition or pointing require high accuracy to correctly identify the user body or body parts or controller movement and/or location in space.

In that scenario, the gestures might include some obstruction of the controllers by other controllers or by other body parts with regard to the system, and might create problem when trying to estimate the movement or the location of the controllers or the body part when there is no line of sight between the controller or the body part and the capturing aperture.

Currently, there is a variety of methods used for identifying an object such as a user or a controller in a scene for example in a virtual reality (VR) or augmented reality (AR) environment.

Some of the currently used methods and devices include a combination of accelerometers and optical sensing (such as in Wii remote). The disadvantage of using accelerometers relates to the drift in the inertial measurement systems, which means that accurate tracking of movement using such devices might be subject to cumulative errors, and might result in error when trying to estimate the position from the movements tracked by such devices. Using optical point devices might be a problem when the line of sight from the pointing device to the receiving aperture is obstructed by other controllers or by the user's body.

Other solutions known in the art include the use of active light source with detectors on the controller (such as Vive), which require a large amount of detectors to make sure that regardless of the user's position or orientation, sufficient amount of detectors have line of sight with the active light source to deal with obstructions.

### SUMMARY OF INVENTION

According to a first aspect there is provided a system comprising at least one controller for controlling a computer device, the controller comprising a plurality of Radio Frequency (RF) transmitting units or repeating units, said RF transmitting units are configured to generate RF signals said RF signals differ in frequency and/or time and/or coding scheme between said units in a scene; a receiver comprising a plurality of RF receiving units, said RF units are configured to receive reflections of the RF signals; and

a computer processor configured to analyze the RF reflected signals and measure the location and/or orientation of said controller in said scene.

In an embodiment the controller is configured to modulate said controller transmitted RF signal and embedding a unique signature by modulation in frequency domain and\or time domain and\or coding scheme to be identified by said RF receiving units.

In an embodiment the unique signature is accomplished by connecting the antenna port of said controller to a RF switch toggling the load of the antenna between short and open states at a predefined frequency and said frequency is the unique signature.

In an embodiment the unique signature can be accomplished by demodulating the received RF signals and retransmitting it by offsetting it in time and/or frequency.

In an embodiment the controller is attached to or part of a user accessory.

In an embodiment the positions of multiple controllers is used determine the orientation of objects in space.

In an embodiment the RF transmitting units or repeating units are active.

In an embodiment the RF transmitting units or repeating units are passive. In an embodiment the device is an electronic device selected from the group consisting of: computer device, mobile telephone, tablet.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks, according to embodiments of the invention, could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein, are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

The subject matter disclosed may best be understood by reference to the following detailed description when read with the accompanying drawings in which:

FIG. 1A is a diagram illustrating a system comprising an active transmitting controller and a receiving aperture, according to some embodiments;

FIG. 1B is a diagram illustrating a system comprising a repeating controller device, according to some embodiments;

FIG. 2 illustrates an RF measuring system configured to measure an object location and/or orientation in space, in accordance with embodiments;

FIG. 3A is a diagram illustrating a controller comprising multi antennas bracelet, according to some embodiments;

FIG. 3B is a diagram illustrating a receiving aperture comprising multi antenna pillar, according to some embodiments;

FIG. 4 illustrating an upper view of a system for measuring the location of one or more users such as person located at the center of a scene, according to some embodiments;

FIG. 5 is a flowchart of a method for identifying a location and/or orientation of an object using a transmitter and a receiver, according to some embodiments;

FIG. 6 is a flowchart of a method for identifying a location and/or orientation of an object using a transmitter and a repeater, according to some embodiments; and

FIG. 7 illustrates an example of a transponder and/or repeater scheme in accordance with one embodiment.

### DETAILED DESCRIPTION OF THE INVENTION

The invention relates to a system, device and method for measuring an object location and/or orientation in space, and more specifically, but not exclusively, to a system, device and method for measuring one or more objects location and orientation in space using multi-RF (Radio Frequency) units.

According to one embodiment, there is provided a system for measuring an object location and/or orientation, comprising: a controller, which comprises a plurality of transmitters or repeaters configured to transmit or repeat RF signals to a receiver. The receiver comprises a plurality of receiving units, such as receiving antennas configured to receive the signals from the controller, and may include a transmitter if the controller is repeating the signal. The system further comprises a processing unit for estimating and measuring the controller location and orientation in space, such as in 3D space.

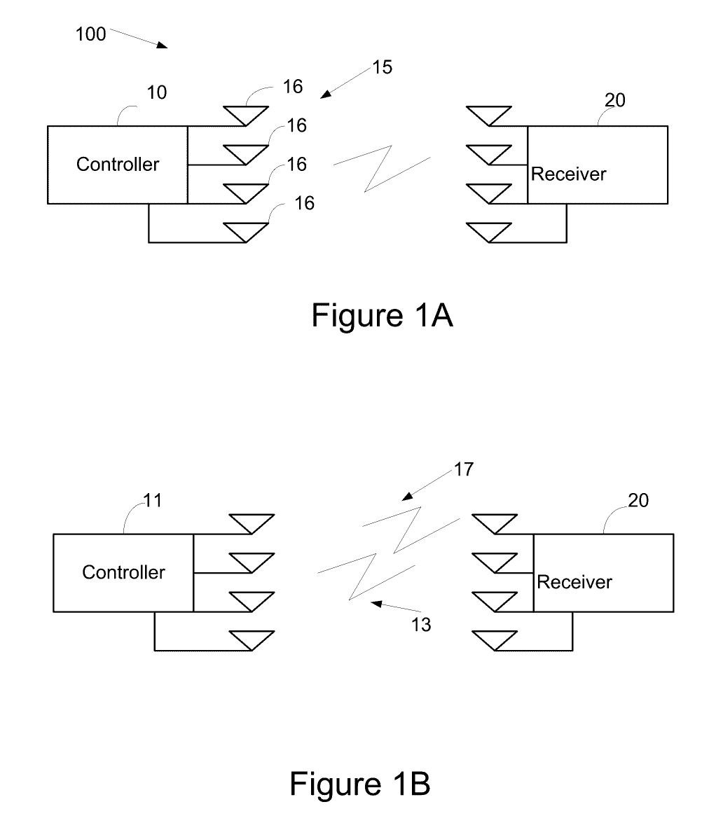

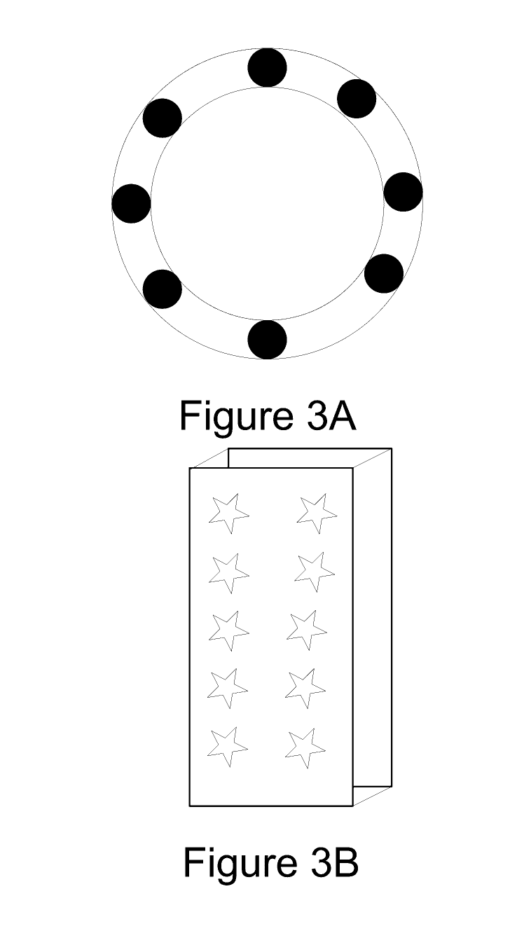

Reference is now made to FIG. 1A illustrating a system 100 for measuring an object location and orientation in a scene, according to one embodiment of the invention. In an embodiment the object may be a controller 10 such as an input device used for controlling a device for example for playing video games. In another embodiment the object may be part of a user's garment or bracelet as shown in FIG. 3A and may be configured to identify the user location and orientation in 3D in a space for example in the user's room or in a VR (Virtual Reality) or AR (Augmented reality) environment.

The controller of FIG. 3A comprising multi antennas bracelet, which may worn on user hand. The location of each antenna can be determined by the method described below, and as such both the location and orientation of the bracelet can be estimated.

The controller 10 comprises one or more RF transmitting or repeating units for example an RF antenna array 15 such as a multiple antennas 16, each connected to a separate transmitting or repeating module allowing phase and\or amplitude and\or time and\or coding modulation between antennas, or several clusters of antennas, where each cluster is connected to a separate transmit or repeat module. The RF array 15 is configured to generate RF signals such as high bandwidth RF signals that can be, for example, in the 3-10 GHz band, which may be unique to each array or repeating units by using frequency modulation and\or time modulation and\or coding scheme for each antenna, or each site. By transmitting different frequencies and\or at different times or\and using different coding schemes from each site it is possible to separate between signals sent from different sites. This enables simultaneous transmission from all sites on a single controller, or all controllers at once, for example, for orientation measurements we may repeat and\or transmit from all the RF units on the controller at the same time, using different modulation. For multi controllers, we may repeat and\or transmit from all controllers at once, using different modulation.

For example these signals may be microwave signals in the UWB band 3-10 Ghz (having a wavelength of 3-10 cm in air), and may be stepped-CW (sinus), chirps, shaped/coded pulses or other waveforms.

The system 100 further comprises a receiver 20 for receiving the RF signals provided by the controller 10. The receiver 20 comprises a number of RF transmitting or receiving units 25, for example in the form of an RF antenna array including 5, 10, 15 or 20 antennas. In an embodiment the receiver 20 may be the source of the RF signals being repeated by the controller 10, or might be completely passive, using only receiving modules. The receiving units may be configured in a single unit, for example as shown in FIG. 3B the receiving unit may be attached or included in a housing 300. In some embodiments the housing 300 may be attached to a room ceiling.

Specifically FIG. 3B is a diagram illustrating a receiving aperture comprising multi antenna pillar, which can be placed on the floor, or hung on the ceiling. Each antenna is used to determine the location of the controllers, according to some embodiments of the present invention; and

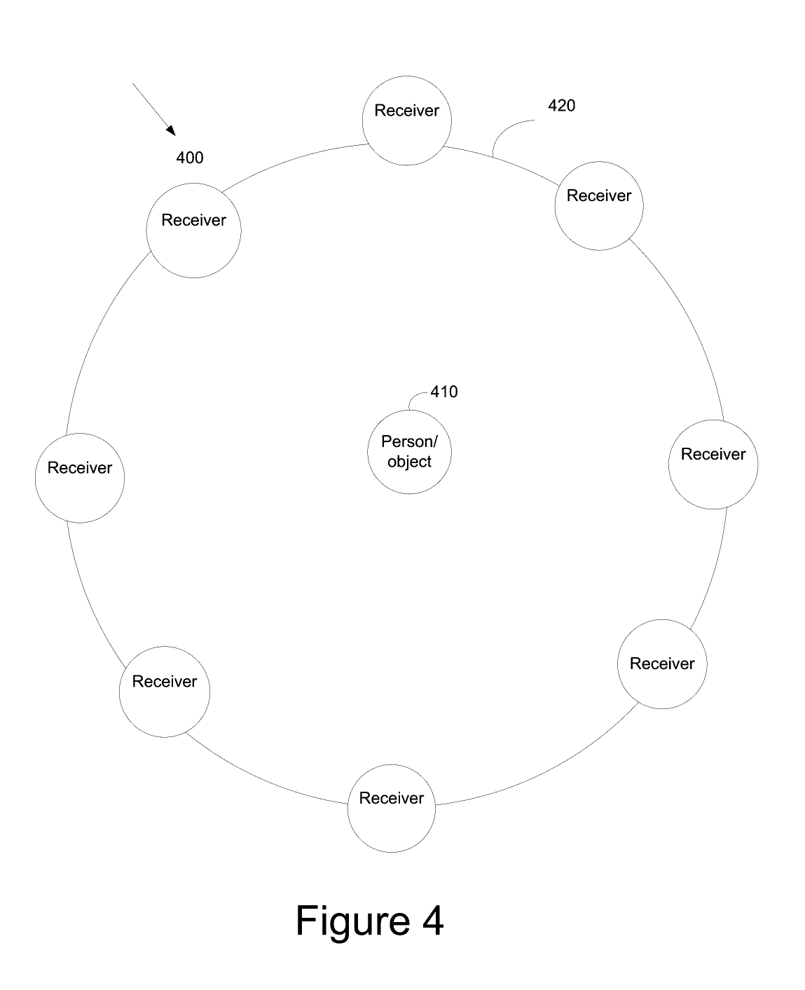

In another embodiment, as shown in FIG. 4 the receiving units may be placed at several locations in room.

Additionally, the system 100 comprises a processing unit, which receives the signals, for example from the receiving units and utilizes the signal received by the receiving units to estimate/measure the location and orientation of the controller(s). The measurement is calculated using several methods based on the time of arrival to one or many sites, the amplitude of the received signal at on or many sites, or the direction of arrival.

For example, when using time of flight methods, the time of flight from each controller to each receiving site is used to calculate the location of the controller in the following method: consider \vec{X}_{c} the location of the controller, \vec{X}ᵢ the location of receiving site i, and t_{ci} the time of flight between the controller c and the receiving site i. The following system of equations can be solved using iterative non-linear least square method to estimate the location of the controller: |\vec{X}_{c}−\vec{X}ᵢ|=t_{ci} for each i.

Using the difference between times of receiving signals from different sites can be solved in a similar method, using for example site i, j in locations \vec{X}ᵢ, \vec{X}ⱼ: |\vec{X}_{c}−\vec{X}ᵢ|−|\vec{X}_{c}−\vec{X}ⱼ|=t_{ci}−t_{cj} for each i.
If several controllers are present on a bracelet, for example, their relative locations can be used to estimate the orientation of the bracelet.

FIG. 1B is a diagram illustrating a system comprising a repeating controller 11, which might be active (e.g. amplifying the receiving signal, modulating it according the specific controller, and transmitting it to the receiving aperture) or passive (e.g. only modulating the received signal in time and\or frequency and\or coding scheme according to the specific controller and transmitting to the receiving aperture). The signal received by the controller may be transmitted from the receiving aperture, or from a different device. Specifically as shown in FIG. 1B includes at least one original signal 13 transmitted from the receiver 20 to the controller 11 and at least one modulated signal 17 transmitted from the controller 11 to the receiver 20.

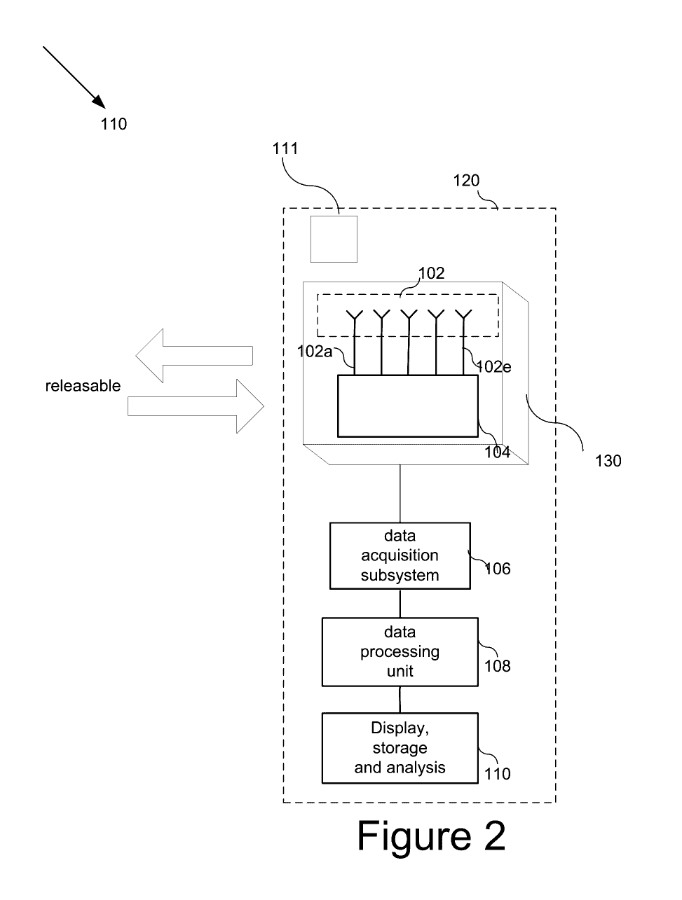

FIG. 2 illustrates an RF measuring system 110 configured to measure an object location and/or orientation in space, in accordance with embodiments of the invention. The system 110 comprises a measurement unit 130 configured to be attached or included in a device such as a portable device 120 for example the controller. According to some embodiments, the portable device 120 may be a handheld device or a handheld computer such as a mobile telephone, a smart phone, a tablet computing device, a laptop computing device, a personal digital assistant, a visible light camera, a personal video device or a music player, personal media player, global positioning system navigational device, pager, portable gaming device or any other appropriate mobile device known in the art. For example, the measurement unit 130 may be used to identify a location of an object (e.g. user) within space and provide an identification results relating to the object to the portable device 120 for use in any desired fashion (e.g., for further processing, to store in memory, to display, to use by various applications running on the portable device 120, to export to other devices, or other uses).

In one embodiment, the sensor unit 130 may be a multi-layer structure implemented at least in part with printed circuit board techniques using appropriate dielectric materials. Commonly used materials are glass-epoxy, Teflon-based materials. Layers of high-dielectric-constant materials can be incorporated in order to match the antennas to materials under test.

The measurement unit 130 may include or may be connected to a transmit/receive subsystem 104, a data acquisition subsystem 106, a data processing unit 108, additional sensors such as accelerometer 111 and imager 113 and a console 110.

According to some embodiments of the invention the measurement unit comprises an array, the array comprises one or more transducers, wherein at least one of said at least two transducers is configured to transmit a signal towards a scene, and at least one transceiver attached to the transducers, the at least one transceiver is configured to transmit at least one signal toward the scene and receive a plurality of signals affected by the scene.

Specifically, the measurement unit 130 may include one or more antennas such as antenna array 102. For example the antenna array 102 may include multiple antennas 102a-102e typically between a few and several dozen (for example 30) antennas. The antennas can be of many types known in the art, such as printed antennas, waveguide antennas, dipole antennas or “Vivaldi” broadband antennas. The antenna array can be linear or two-dimensional, flat or conformal to the region of interest.

According to some embodiment of the invention the antenna array 102 may be an array of flat broadband antennae, for example spiral shaped antennae. The antenna array 102 may include a layer of matching material for improved coupling of the antenna radiation to the materials or objects under test. The unique and optimized shape of the antenna array, enables their use in limited sized mobile devices, such as a thin, small-sized smart phone or tablet. In addition, the use of an antenna array made as flat as possible, for example in a printed circuit, allows for the linkage of the measurement unit 130 to any mobile device known in the art, as it does not take up much space in the mobile device, it is not cumbersome, nor does it add significant weight to the portable device 120.

In some cases the measurement unit 130 may be a standalone unit, for example attached to or connected to a computer device via wire or wireless connections such as USB connection or Bluetooth™ or any electronic connection as known in the art.

The transmit/receive subsystem 104 is responsible for generation of the microwave signals, coupling them to the antennas 102a-102e, reception of the microwave signals from the antennas and converting them into a form suitable for acquisition. The signals (e. g. RF signals) can be pulse signals, stepped-frequency signals, chirp signals and the like. The generation circuitry can involve oscillators, synthesizers, mixers, or it can be based on pulse oriented circuits such as logic gates or step-recovery diodes. The conversion process can include down conversion, sampling, and the like. The conversion process typically includes averaging in the form of low-pass filtering, to improve the signal-to-noise ratios and to allow for lower sampling rates. The transmit/receive subsystem 104 can perform transmission and reception with multiple antennas at a time or select one transmit and one receive antenna at a time, according to a tradeoff between complexity and acquisition time.

The data acquisition subsystem 106 collects and digitizes the signals from the transmit/receive subsystem 104 while tagging the signals according to the antenna combination used and the time at which the signals were collected. The data acquisition subsystem will typically include analog-to-digital (A/D) converters and data buffers, but it may include additional functions such as signal averaging, correlation of waveforms with templates or converting signals between frequency and time domain.

The data acquisition subsystem 106 may include a Radio Frequency Signals Measurement Unit (RFSMU) such as a Vector Network Analyzer (VNA) for measuring the received/reflected signals.

The data processing unit 108 is responsible for converting the collected signals into a set of responses characterizing the object, and performing the algorithms for converting the sets of responses, for example into medium sensing data.

An example of algorithm for converting the sets of responses may be for example Delay and Sum (DAS) algorithm described above.

According to some embodiments, the system may include an accelerometer 111 to fine tune and give additional data in respect to the movement, the distance of the device.

A final step in the process is making use of the resulting parameters or image, either in the form of visualization, display, storage, archiving, or input to feature detection algorithms. This step is exemplified in FIG. 1A as console 110. The console for example in a mobile device is typically implemented as a handheld computer such as a mobile telephone or a table computer with appropriate application software.

According to system type, the computer can be stationary, laptop, tablet, palm or industrial ruggedized. It should be understood that while FIG. 1A illustrates functional decomposition into processing stages, some of those can be implemented on the same hardware (such as a common processing unit) or distributed over multiple (such as graphical processing unit, GPU) and even remote pieces of hardware (such as in the case of multiprocessing or cloud computing).

According to one embodiment of the invention, subsystems 106, 108 and 110 may be part of the measurement unit or the portable device 120, as shown in FIG. 1A. Alternatively the measurement unit 130 may be included within a housing 125 such as case or a jacket configured to be releasable (i.e. connected or disconnected) to the portable device 120. For example the measurement unit 130 may include the antenna array unit 102 and the transmit/receive-subsystem 130 may be part of the housing 125 which is electrically or wirelessly connected to the portable device 120, for example through a dedicated connection such a USB connection, wireless connection or any connection known in the art.

Following the connection of the sensor unit 130 to the portable device, the sensor unit 130 may utilize the portable device's own data acquisition, data processing display, storage and analysis subsystems.

Reference is now made to FIG. 4 illustrating an upper view of a system 400 for measuring the location of one or more users such as person 410 located at the center of a scene 420. The system comprises a number of RF receivers, for example surrounding the one or more users. A plurality of RF transmitters is attached to the users for transmitting RF signals to the scene. In operation, each transmitter or repeater unit on the person modulates the transmitted or repeated signal at different modulation, thus enabling the localization of each transmitter \repeater separately, their orientation with regard to each other, and the position of the person.

Specifically, FIG. 4 is a diagram illustrating multiple receiving apertures, used to improve the resolution of the estimation of the controllers' location and orientation, according to some embodiments of the present invention.

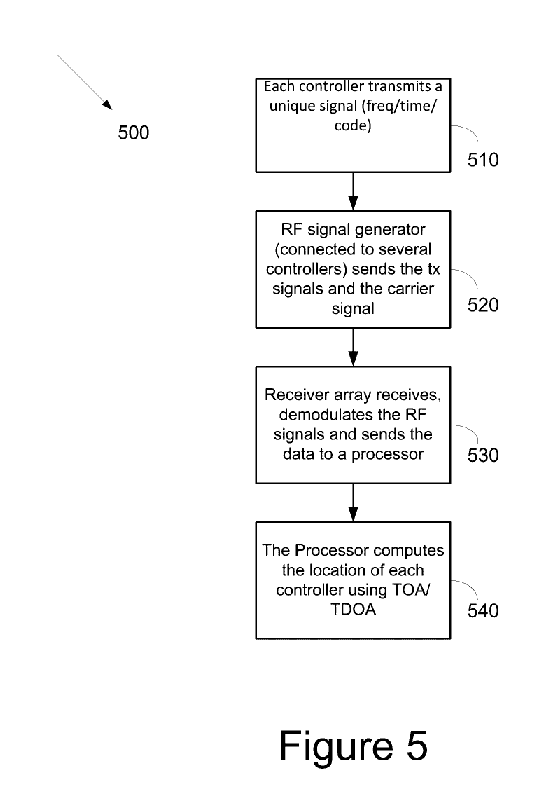

FIG. 5 is a flowchart 500 of a method for identifying a location and/or orientation of an object using a transmitter and a receiver as shown for example in FIG. 1A. At step 510 each controller such as controller 10 transmits a unique signal that can be modulated either in frequency domain, time domain or coding scheme). At step 520 each RF signal generator sends one or more tx signals and the carrier signal. At step 530 the receiver array (e.g. receiver 20) receives, demodulates the RF signals and sends the data to a processor such as processor 108 of FIG. 2. At step 540 The Processor computes the location of each controller using for example TOA/TDOA (Time of Arrival) methods.

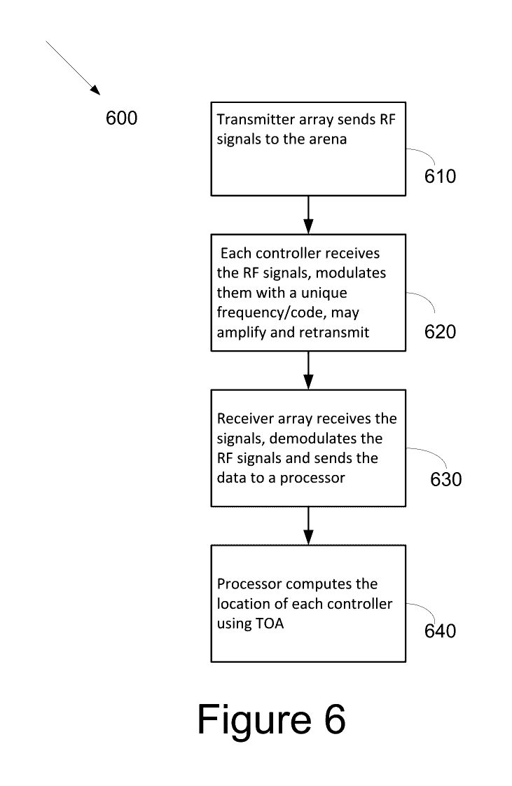

FIG. 6 is a flowchart 600 of a method for identifying a location and/or orientation of an object using a transmitter and a repeater as shown for example in FIG. 1B.

At step 610 transmitter array sends RF signals to the arena or scene. For example as shown in FIG. 1B the transmitter (e.g. controller 10 which is a repeating controller) sends a modulated signal to the receiver 20. At step 620 the controller for example each controller receives the RF signals, modulates them with a unique frequency/code, which may further retransmitted. At step 630 the receiver array (e.g. receiver 20) receives the signals, demodulates the RF signals and sends the data to a processor. At step 640 the processor computes the location of each controller using for example TOA methods. It is stressed that other methods may be used to compute the location of the object or the controller.

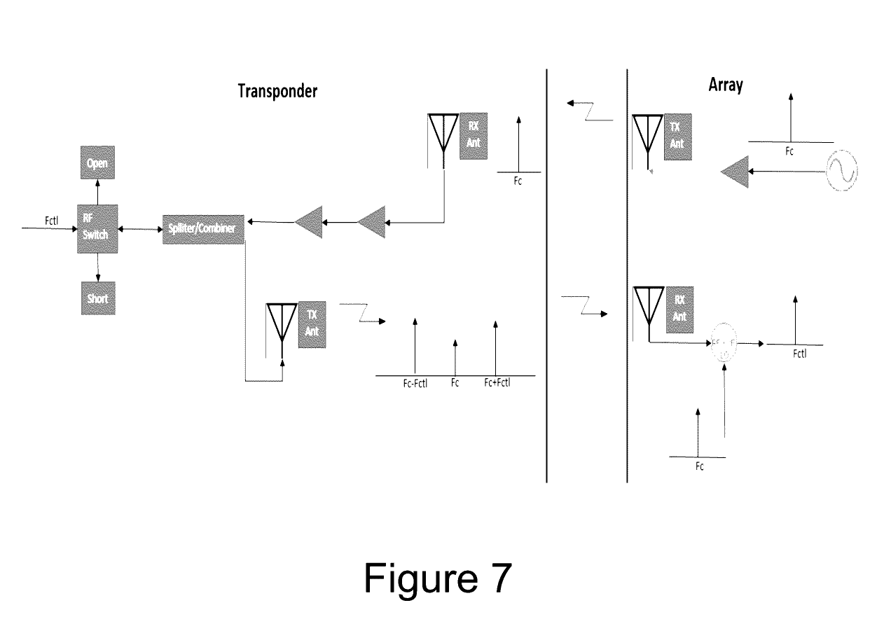

FIG. 7 illustrates an example of a transponder and/or repeater Scheme in accordance with one embodiment.

In further embodiments, the processing unit may be a digital processing device including one or more hardware central processing units (CPU) that carry out the device's functions. In still further embodiments, the digital processing device further comprises an operating system configured to perform executable instructions. In some embodiments, the digital processing device is optionally connected a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

In accordance with the description herein, suitable digital processing devices include, by way of non-limiting examples, server computers, desktop computers, laptop computers, notebook computers, sub-notebook computers, netbook computers, netpad computers, set-top computers, handheld computers, Internet appliances, mobile smartphones, tablet computers, personal digital assistants, video game consoles, and vehicles. Those of skill in the art will recognize that many smartphones are suitable for use in the system described herein. Those of skill in the art will also recognize that select televisions with optional computer network connectivity are suitable for use in the system described herein. Suitable tablet computers include those with booklet, slate, and convertible configurations, known to those of skill in the art.

In some embodiments, the digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®.

In some embodiments, the device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In some embodiments, the digital processing device includes a display to send visual information to a user. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In other embodiments, the display is a video projector. In still further embodiments, the display is a combination of devices such as those disclosed herein.

In some embodiments, the digital processing device includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera to capture motion or visual input. In still further embodiments, the input device is a combination of devices such as those disclosed herein.

In some embodiments, the system disclosed herein includes one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device.

In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media. In some embodiments, the system disclosed herein includes at least one computer program, or use of the same. A computer program includes a sequence of instructions, executable in the digital processing device's CPU, written to perform a specified task. Computer readable instructions may be implemented as program modules, such as functions, objects, Application Programming Interfaces (APIs), data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Android™ Market, BlackBerry® App World, App Store for Palm devices, App Catalog for webOS, Windows® Marketplace for Mobile, Ovi Store for Nokia® devices, Samsung® Apps, and Nintendo® DSi Shop.

In some embodiments, the system disclosed herein includes software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

In some embodiments, the system disclosed herein includes one or more databases, or use of the same. In view of the disclosure provided herein, those of skill in the art will recognize that many databases are suitable for storage and retrieval of information as described herein. In various embodiments, suitable databases include, by way of non-limiting examples, relational databases, non-relational databases, object oriented databases, object databases, entity-relationship model databases, associative databases, and XML databases. In some embodiments, a database is internet-based. In further embodiments, a database is web-based. In still further embodiments, a database is cloud computing-based. In other embodiments, a database is based on one or more local computer storage devices.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A system comprising:
at least one controller for controlling a computer device, the controller comprising a plurality of Radio Frequency (RF) transmitting units or repeating units, said RF transmitting units are configured to generate RF signals said RF signals differ in frequency and/or time and/or coding scheme between said units in a scene;
a receiver comprising a plurality of RF receiving units, said RF units are configured to receive reflections of the RF signals; and
a computer processor configured to analyze the RF reflected signals and measure the location and/or orientation of said controller in said scene.

2. The system of claim 1 wherein said controller is configured to modulate said controller transmitted RF signal and embedding a unique signature by modulation in frequency domain and\or time domain and\or coding scheme to be identified by said RF receiving units.

3. The system of claim 1 wherein said unique signature is accomplished by connecting the antenna port of said controller to a RF switch toggling the load of the antenna between short and open states at a predefined frequency and said frequency is the unique signature.

4. The system of claim 1 wherein said unique signature can be accomplished by demodulating the received RF signals and retransmitting it by offsetting it in time and/or frequency.

5. The system of claim 1 wherein said controller is attached to or part of a user accessory.

6. The system of claim 1 wherein positions of multiple controllers is used determine the orientation of objects in space.

7. The system of claim 1 wherein RF transmitting units or repeating units are active.

8. The system of claim 1 wherein said RF transmitting units or repeating units are passive.

9. The system of claim 1 wherein the device is an electronic device selected from the group consisting of:
computer device, mobile telephone, tablet.
